(19) United States
(12) Patent Application Publication
(10) Pub. No.: US 2025/0296892 A1
(43) Pub. Date: Sep. 25, 2025

(54) COMPOSITION FOR GRANULAR AND LIQUID PHOSPHORUS FERTILIZERS

(71) Applicant: PRIVATE COMPANY LIMITED BY SHARES INNOVATION AGRO GROUP LIMITED, Sheung Wan, Hong Kong, Hong Kong (CN)

(72) Inventor: Vitaliy Aleksandrovich IZOSIN, Magnitogorsk, Chelyabinskaya obl. (RU)

(21) Appl. No.: 18/863,146

(22) PCT Filed: May 8, 2023
(86) PCT No.: PCT/RU2023/050109

§ 371 Date: Nov. 5, 2024

(30) Foreign Application Priority Data
May 6, 2022 (RU) 2022112389

(51) Int. Cl. C05B 7/00; C05G 3/40; C05G 3/50; C05G 5/12; C05G 5/20

(52) U.S. Cl. CPC C05B 7/00; C05G 3/40; C05G 3/50; C05G 5/12; C05G 5/20

(57) ABSTRACT

This invention relates agricultural chemistry, specifically to phosphorus fertilizers in granular and liquid forms, which may be suitable for growing various crop species on soils of any type. The composition according to the invention comprises a granular phosphorus fertilizer produced by introducing functional additives into the ammonium phosphate pulp before feeding the pulp into a drum granulator-dryer (DGD), or a liquid phosphorus fertilizer produced by introducing functional additives into liquid phosphorus fertilizer under stirring the resulting mixture to form a homogeneous composition, in both cases in the following amounts (wt. %): granular or liquid phosphorus fertilizer 50.0-99.9%; polymaleic acid 0.05-25.0%, and polyamino polyether methylene phosphonic acid 0.05-25.0%. This makes it possible to prevent binding phosphorus into slightly soluble metal salts, thus increasing the available phosphorus concentration, which is achieved due to the synergistic effect of the inhibitor composition, wherein the effect of one component is enhanced in the presence of another.

### TECHNICAL FIELD

This invention relates to the field of agricultural chemistry, specifically to phosphorus fertilizers in granular and liquid forms, which may be suitable for growing various crop species on soils of any type.

### STATE OF THE ART

Phosphorus is one of the main sources of plant nutrition, and its content in the soil determines the plant growth and development as well as the yield and quality of the resulting agricultural products. Agricultural chemistry discloses the exact amounts of phosphorus consumed by plants from the soil during vegetation (for example, the average value for wheat is 10 to 12 kg per 1 ton of grain) [V. G. Chernenok, “Scientific principles and practical methods for managing soil fertility and crop productivity in Northern Kazakhstan”, Astana, 2009]. To replenish the phosphorus spent from the soil, the necessary amounts of phosphorus fertilizers are applied. The concentration of active phosphorus in the soil is usually low, because when it is applied to the soil, it quickly reacts with calcium (Ca), magnesium (Mg), iron (Fe) and aluminum (Al) to form slightly soluble (and therefore unavailable for nutrition) salts, which are metal phosphates.

Due to the high rate of phosphorus binding in the soil due to the formation of slightly soluble salts, the urgent problems are to prolong the presence of fertilizer phosphorus in an active form in the soil without the formation of slightly soluble salts and to convert total phosphorus bound in slightly soluble salts into an accessible form, i.e. to convert a part of phosphorus bound in slightly soluble salts into active phosphorus, which is available for plants.

There is a wide range of the known phosphorus fertilizers used in agriculture [M. E. Pozin, “Technology of mineral fertilizers”, Moscow: Khimiya, 1989]. The main types of currently used phosphate granular fertilizers comprise superphosphate, double superphosphate, ammophos, diammophos, orthophosphate, and potassium metaphosphate. Phosphorite meal is also used.

These types of phosphorus fertilizers are characterized by a low percentage of phosphorus uptake by plants due to the formation of slightly soluble phosphate salts. This process is described in detail [A. E. Vozbutskaya, “Soil chemistry”, Moscow: Vysshaya Shkola, 1968] as “fertilizer retrogradation” (Latin retrogrades means going back), i.e. conversion of mobile forms of nutrients with easy plant uptake into non-available or hardly available compounds. Phosphorus fertilizers retrograde to a greater extent, especially in acidic soils. When they are introduced into the soil, water-soluble and citrate-soluble calcium phosphates are converted into tricalcium phosphates, iron and aluminum phosphates, or into organic phosphates. Fertilizer nutrient retrogradation can have a long-term negative impact on plant yields.

When used before sowing and scattered for plowing, the utilization coefficient of phosphorus from superphosphate in the year of its application is only 10 to 15% of the applied amount [“Agrochemistry”, 2nd ed., revised and supplemented, eds. P. M. Smirnov and E. A. Muravin].

There are known liquid phosphorus fertilizers (liquid complex fertilizers or LCF) based on soluble phosphates and ammonium polyphosphates (for example, PhosAgro PJSC produces LCF NP 11:37 with a phosphorus content 37% in terms of P₂O₅). Fertilizers such as LCF have certain agrochemical advantages as compared to other types of phosphorus fertilizers since they comprise ammonium polyphosphates that do not form slightly soluble salts.

However, the disadvantage of LCF fertilizers is that they are produced only in the form of aqueous solutions. LCS solutions contain water, which is inert and causes additional costs for their transportation and storage.

Furthermore, LCF phosphates comprise 20% orthophosphates, which are bound by the soil immediately after application like ordinary phosphate to form slightly soluble salts. Since a plant absorbs phosphorus precisely in the form of phosphates, remaining 80% of LCF phosphorus in the form of polyphosphates should be hydrolyzed in the soil to orthophosphates for a long time, which negatively affects the nutrition of plants during the growing season, i.e. during the development period, the plant will not receive the necessary phosphorus nutrition. At the same time, the hydrolysis of polyphosphates to orthophosphates is followed by the above process of phosphorus binding into slightly soluble non-available salts consisting of metal phosphates.

Meanwhile, the preparation of liquid mineral fertilizers from granular ammophos (diammophos) is difficult due to the very slow and incomplete solubility of phosphate raw materials. Furthermore, the production and use of liquid phosphorus fertilizers does not solve the problem of phosphate binding by soil-forming elements.

A rational way to solve the above problem is to search for additives that inhibit the course of negative processes of phosphate binding by the soil to form slightly soluble salts.

Patent applications disclose the following technical solutions for the problem of phosphorus binding and formation of slightly soluble salts.

Patent No. RU 2675822 “Fertilizers with polyanion polymers and a method for application of polyanion polymer on plants” of 25 Dec. 2018 discloses anionic polymers with repeating units of four types used as independent products or fertilizer products and having a number of valuable properties for use in agriculture, including the ability to enhance the plant uptake of nutrients from fertilizers (particularly phosphorus, nitrogen, potassium and trace elements), to act as enhancers of pesticides such as glyphosate herbicides and, when supplemented with an organic desiccant, to dry very quickly when applied to solid fertilizers, thereby facilitating the preparation of finished products in the form of coated solid fertilizers.

Furthermore, preferred polymers have been shown to have increased activity when using fertilizer compositions comprising partial polymer salts various types (US Patent Publication No. 2009/0217723 of 3 Sep. 2009). This technology is also disclosed in U.S. Pat. Nos. 6,515,090; 7,655,597; 7,736,412; and 8,043,995. The efficacy comparison vs. control, for example, in terms of phosphate activation when using polymers shows an increase in the concentration of active phosphates in plant tissues by 18% and an increase in yield by 20% (tests were carried out on cotton).

Patent No. RU 2267499 of 10 Jan. 2006 “Anionic polymers formed from dibasic carboxylic acids and use thereof” discloses anionic polymers formed from dicarboxylic monomers such as maleic anhydride, itaconic anhydride or citraconic anhydride. Free-radical polymerization is used for the synthesis of polymers. The polymers may form complexes with ions and/or mixtures with fertilizers or seeds to prepare agriculturally suitable compositions. The preferred products of the invention may be applied to the leaves or to the ground in the vicinity of growing plants in order to improve the plant uptake of nutrients. The efficacy comparison vs. control, for example, in terms of phosphate activation when using carboxylate polymers shows an increase in the dry weight gain of corn by 41.9% on acidic soils and 15.9% for alkaline soils.

However, the disadvantages of the compositions disclosed in the said patents are the complex composition of the polymers, the complex synthesis, the lack of these polymers in the free market, the limited solubility of the polymers in concentrated solutions of phosphorus fertilizers, and the inability to add these polymers to granular products.

Moreover, the disadvantage of the said inhibitors is that it is proposed to apply them either to the surface of the granule, or to add them directly to the soil, which makes their efficacy doubtful, since inhibitors are washed off the granules by the atmospheric precipitations, while an addition of inhibitors to the soil can lead to soil depletion without further phosphorus nutrition.

Problems solved by the invention. It is necessary to develop a composition for phosphorus fertilizer that can prevent the binding of phosphates into slightly soluble salts, with the introduction of inhibitors directly into the fertilizer composition. An additional positive effect from the use of this composition is manifested in the ability to dissolve slightly soluble phosphates previously formed in the soil, thus converting bound phosphorus into an active (available) form, as well as an enhanced mobility of other ions bound into slightly soluble phosphates.

### SUMMARY

### Technical Effects of the Invention

prevention of phosphorus binding into slightly soluble metal salts to increase the concentration of available phosphorus by supplementing the composition of phosphorus fertilizers with the inhibitors of the formation of slightly soluble salts; and
synergistic effect of the composition of inhibitors, wherein the effect of one component is enhanced in the presence of another.

These technical effects are achieved by using a composition of biodegradable polyanionic polymers based on polycarboxylic and organophosphorus in the optimal ratio as a functional additive. This mixture prevents the binding of fertilizer phosphorus into slightly soluble phosphates, thus increasing the concentration of active phosphorus in the soil when applying phosphorus fertilizers. The use of the composition according to the invention makes it possible to reduce significantly the loss of phosphorus due to binding into slightly soluble salts when using phosphorus fertilizers.

The particular embodiments of the invention are given below.

A composition for phosphorus fertilizers (first embodiment) comprising a granular phosphorus fertilizer and functional additives, which comprise (wt. %):

| | |
|---|---|
| Granular phosphorus fertilizer* | 50.0-99.9% |
| Polymaleic acid | 0.05-25.0% |
| Polyamino polyether methylene phosphonic acid | 0.05-25.0% |

*Granular phosphorus fertilizer is ammophos or diammophos.

A composition for phosphorus fertilizers (second embodiment) comprising a liquid phosphorus fertilizer and functional additives, which comprise (wt. %):

| | |
|---|---|
| Liquid phosphorus fertilizer* | 50.0-99.9% |
| Polymaleic acid | 0.05-25.0% |
| Polyamino polyether methylene phosphonic acid | 0.05-25.0% |

*Liquid phosphorus fertilizer is LCF NP 11:37.

### Implementation of the Invention

Phosphorus granular fertilizers and phosphorus liquid fertilizers in the proposed amounts serve as the main source of phosphorus nutrition for plants.

A mixture of polymaleic acid and polyamino polyether methylene phosphonic acid at the specified ratio in the proposed amounts is used to prevent the binding of phosphorus into slightly soluble metal salts, thus increasing the concentration of available phosphorus by supplementing the composition of phosphorus fertilizers with the inhibitors of the formation of slightly soluble salts.

Empirically, the applicant has determined that the best quality of the composition to prevent the binding of phosphorus into slightly soluble metal salts was achieved by using a mixture of anionic polymers based on polycarboxylic and organophosphorus compounds. In the course of the experiments carried out by the applicant, it was determined that, in order to achieve these technical effects, it is most optimal to use the following substances:
polymaleic acid registered under international CAS No. 26099-09-2; and
polyamino polyether methylene phosphonic acid registered under international CAS No. 130668-24-5.

When preparing the claimed agent, the chemicals included in its composition react with each other to provide the compositions for granular and liquid fertilizers and allow solving the problems due to the synergistic effect, wherein the action of one component is enhanced in the presence of another. Namely, due to the synergistic effect of the set of the used components of the composition for granular and liquid fertilizers at the stated quantitative ratio thereof, the problems were solved, and the said technical effects were achieved as was confirmed experimentally.

The concentration and ratio of phosphorus fertilizers and inhibitors of the formation of slightly soluble phosphate salts were selected on the basis of the studies presented in Tables 2-10.

The technique for preparing the claimed composition for granular phosphorus fertilizers can be implemented with the well-known equipment used in industrial conditions, for example, with the existing production line for the manufacture of granular phosphorus fertilizers (ammophos and diammophos) by introducing solutions of the proposed composition of inhibitors at the stage of preparing ammonium phosphate pulp before feeding the pulp into the drum granulator-dryer (DGD).

The equipment used in the production of granular phosphorus fertilizers is described in the technological literature; see, for example, A. A. Sokolovskiy and E. V. Yashke, “Technology of mineral fertilizers and acids. Manual for technical schools”, 2nd ed., revised and supplemented, Moscow: Khimiya, 1979, 384 pages.

The technique of preparing the claimed composition for liquid phosphorus fertilizers can be implemented by adding inhibitors of the formation of slightly soluble salts in the proposed ratios directly to the liquid phosphorus fertilizer with liquid phosphorus fertilizers under stirring the resulting mixture to form a homogeneous composition.

### EXAMPLES

The essence of the claimed invention is illustrated by examples of the preparation of the claimed compositions.

The claimed composition for granular fertilizer was prepared as described above, but in laboratory conditions (Table 1 presents specific examples illustrating the invention).

The claimed composition (first and second embodiments) was prepared from the calculated amounts of ammophos or diammophos, polymaleic acid, and polyamino polyether methylene phosphonic acid. The starting components were weighed on a scale. In a 25 l glass-lined reactor equipped with a stirrer, a pulp was created from the calculated amount of ammophos by adding a solution containing the calculated amount of polymaleic acid and polyamino polyether methylene phosphonic acid. Then the resulting mixture of ammophos, polymaleic acid and polyamino polyether methylene phosphonic acid was dried and granulated with a laboratory granulator.

The inventive composition (third embodiment) is made from the calculated amount of LCF NP 11:37, polymaleic acid, and polyamino polyether methylene phosphonic acid. The starting components were weighed on a scale. A 25 l glass-lined reactor equipped with a stirrer was filled with LCF. Then, under stirring, a solution of polymaleic acid and polyamino polyether methylene phosphonic acid were added. Stirring was continued until the components were completely mixed to form a homogeneous composition.

TABLE 1

| | Composition | Composition | Composition |
|---|---|---|---|
| Ingredients (wt. %) | 1 | 2 | 3 |

Embodiment 1

| | | | |
|---|---|---|---|
| Ammophos | 50.0 | 74.9 | 99.9 |
| Polymaleic acid | 25.0 | 12.55 | 0.05 |
| Polyamino polyether | 25.0 | 12.55 | 0.05 |
| methylene phosphonic acid | | | |

Embodiment 2

| | | | |
|---|---|---|---|
| Diammophos | 50.0 | 74.9 | 99.9 |
| Polymaleic acid | 25.0 | 12.55 | 0.05 |
| Polyamino polyether | 25.0 | 12.55 | 0.05 |
| methylene phosphonic acid | | | |

Embodiment 3

| | | | |
|---|---|---|---|
| LCF NP 11:37 | 50.0 | 74.9 | 99.9 |
| Polymaleic acid | 25.0 | 12.55 | 0.05 |
| Polyamino polyether | 25.0 | 12.55 | 0.05 |
| methylene phosphonic acid | | | |

The efficacy of the composition in terms of the degree of inhibition of the formation of slightly soluble phosphate salts was determined on the basis of measuring and comparing the amount of phosphate ions (not bound into slightly soluble phosphate salts) in an aqueous extract of soil fertilized with phosphorus fertilizer with and without added inhibitors of the formation of slightly soluble salts.

The analysis of phosphate ions in aqueous soil extract was carried out in accordance with EPR (Environmental Protection Regulations) F 14.1:2: 4.112-97 “Quantitative chemical analysis of water, measuring weight concentration of phosphate ions in drinking, surface and waste water by the photometric method with ammonium molybdate”.

1 g of soil (dried Rostov Chernozem) sample, 10 ml of tap water, 1 ml of a solution of ammophos, diammophos or LCF NP 11:37 (30 g per 100 ml of water diluted in 1000 ml of water) with a calculated concentration of polymaleic acid and polyamino polyether methylene phosphonic acid were placed in a capped centrifuge tube, stored for 1 hour, and then centrifuged to isolate a precipitate. Then the concentration of phosphate ions in the aqueous extract was determined.

Similar measurements were carried out without the addition of polymaleic acid, without the addition of polyamino polyether methylene phosphonic acid, and without the addition of inhibitors of the formation of slightly soluble phosphate salts.

The test results are presented in Tables 2-10.

The tests also involved the effect of inhibitors of the formation of slightly soluble phosphate salts on the release of available phosphorus from the soil without the use of phosphorus fertilizers, by dissolving previously formed phosphate salts in the soil.

The test results are presented in Tables 11-13.

Since the main objective of the invention is to preserve the maximum amount of available (not bound into insoluble salts) phosphorus in the soil during the plant growing season, the practical benefit of this invention is to increase the field crop yield.

The scientific literature discloses the exact values for the removal of chemical elements from the soil in the terms of the amounts of the resulting agricultural products; see, for example, L. Yu. Ryzhikh and A. I. Lipatnikov, “Methodological Guide for Practical Exercises in Fertilizer system in crop rotations”, Kazan Federal University, Institute of Ecology and Nature Management, Department of Soil Science, Kazan, 2018.

Based on the studies presented in the application, when using the proposed composition, the concentration of available phosphate ions in the soil increases to 1225.36% when using LCF, to 807.87% when using ammophos, and to 793.93% when using diammophos. This is ensured by the synergistic effect in the action of a mixture of inhibitors of the formation of slightly soluble phosphate salts, as well as due to the dissolution of the salts previously formed in the soil and consisting of metal phosphates.

Thus, under equal conditions of tillage and plant cultivation, based on the tables of removal of elements per unit of production, the actual yield in practice clearly increases.

The most important factor determining the choice of additional components was their availability, relatively low cost, use efficiency, and environmental safety. In addition to expanding the range of fertilizers, the claimed composition, according to the applicant, will be in great demand right now since it will significantly increase the use efficiency of phosphorus granular and liquid fertilizers, which will lead to an increase in crop yield and quality, and will also improve the efficiency of agricultural production. In the applicant's opinion, the inventive composition allows satisfying the long-existing need in a tool for this purpose.

TABLE 2
Results of efficiency measurement of granular fertilizer based on ammophos

| | | | | Ammophos + | Percent increase in |
|---|---|---|---|---|---|
| | | Ammophos + | | polymaleic | available phosphorus |
| | | polyamino | | acid + polyamino | concentration when |
| | | polyether | | polyether | using a mixture of |
| | | methylene | Ammophos + | methylene | inhibitors relative to |
| | Ammophos | phosphonic | polymaleic | phosphonic acid | addition of fertilizer |
| | additive | acid | acid | (composition 1) | without inhibitors |
| Concentration | 21.6 | 83.2 | 55.6 | 174.5 | 807.87 |
| of available | | | | | |
| phosphate ions | | | | | |
| in aqueous soil | | | | | |
| extract, mg/dm³ | | | | | |

TABLE 3
Results of efficiency measurement of granular fertilizer based on ammophos

| | | | | Ammophos + | Percent increase in |
|---|---|---|---|---|---|
| | | Ammophos + | | polymaleic | available phosphorus |
| | | polyamino | | acid + polyamino | concentration when |
| | | polyether | | polyether | using a mixture of |
| | | methylene | Ammophos + | methylene | inhibitors relative to |
| | Ammophos | phosphonic | polymaleic | phosphonic acid | addition of fertilizer |
| | additive | acid | acid | (composition 2) | without inhibitors |
| Concentration | 21.6 | 68.4 | 38.2 | 87.6 | 405.55 |
| of available | | | | | |
| phosphate ions | | | | | |
| in aqueous soil | | | | | |
| extract, mg/dm³ | | | | | |

TABLE 4
Results of efficiency measurement of granular fertilizer based on ammophos

| | | | | Ammophos + | Percent increase in |
|---|---|---|---|---|---|
| | | Ammophos + | | polymaleic | available phosphorus |
| | | polyamino | | acid + polyamino | concentration when |
| | | polyether | | polyether | using a mixture of |
| | | methylene | Ammophos + | methylene | inhibitors relative to |
| | Ammophos | phosphonic | polymaleic | phosphonic acid | addition of fertilizer |
| | additive | acid | acid | (composition 3) | without inhibitors |
| Concentration | 21.6 | 40.2 | 33.3 | 68.4 | 316.66 |
| of available | | | | | |
| phosphate ions | | | | | |
| in aqueous soil | | | | | |
| extract, mg/dm³ | | | | | |

TABLE 5
Results of efficiency measurement of granular fertilizer based on diammophos

| | | | | | Percent increase in |
|---|---|---|---|---|---|
| | | | | Diammophos + | available phosphorus |
| | | Diammophos + | | polymaleic | concentration when |
| | | polyamino | | acid + polyamino | using a mixture of |
| | | polyether | | polyether | inhibitors relative |
| | | methylene | Diammophos + | methylene | to addition of |
| | Diammophos | phosphonic | polymaleic | phosphonic acid | fertilizer without |
| | additive | acid | acid | (composition 1) | inhibitors |
| Concentration | 23.1 | 74.6 | 68.7 | 183.4 | 793.93 |
| of available | | | | | |
| phosphate ions | | | | | |
| in aqueous soil | | | | | |
| extract, mg/dm³ | | | | | |

TABLE 6
Results of efficiency measurement of granular fertilizer based on Diammophos

| | | | | | Percent increase in |
|---|---|---|---|---|---|
| | | | | Diammophos + | available phosphorus |
| | | Diammophos + | | polymaleic | concentration when |
| | | polyamino | | acid + polyamino | using a mixture of |
| | | polyether | | polyether | inhibitors relative |
| | | methylene | Diammophos + | methylene | to addition of |
| | Diammophos | phosphonic | polymaleic | phosphonic acid | fertilizer without |
| | additive | acid | acid | (composition 2) | inhibitors |
| Concentration | 23.1 | 48.5 | 43.2 | 77.1 | 334.67 |
| of available | | | | | |
| phosphate ions | | | | | |
| in aqueous soil | | | | | |
| extract, mg/dm³ | | | | | |

TABLE 7
Results of efficiency measurement of granular fertilizer based on diammophos

| | | | | | Percent increase in |
|---|---|---|---|---|---|
| | | | | Diammophos + | available phosphorus |
| | | Diammophos + | | polymaleic | concentration when |
| | | polyamino | | acid + polyamino | using a mixture of |
| | | polyether | | polyether | inhibitors relative |
| | | methylene | Diammophos + | methylene | to addition of |
| | Diammophos | phosphonic | polymaleic | phosphonic acid | fertilizer without |
| | additive | acid | acid | (composition 3) | inhibitors |
| Concentration | 23.1 | 41.15 | 28.7 | 69.1 | 299.13 |
| of available | | | | | |
| phosphate ions | | | | | |
| in aqueous soil | | | | | |
| extract, mg/dm³ | | | | | |

TABLE 8
Results of efficiency measurement of liquid complex fertilizer

| | | | | | Percent increase in |
|---|---|---|---|---|---|
| | | | | LCF + | available phosphorus |
| | | LCF + | | polymaleic | concentration when |
| | | polyamino | | acid + polyamino | using a mixture of |
| | | polyether | | polyether | inhibitors relative |
| | | methylene | LCF + | methylene | to addition of |
| | LCF | phosphonic | polymaleic | phosphonic acid | fertilizer without |
| | additive | acid | acid | (composition 1) | inhibitors |
| Concentration | 13.8 | 76.1 | 49.8 | 169.1 | 1225.36 |
| of available | | | | | |
| phosphate ions | | | | | |
| in aqueous soil | | | | | |
| extract, mg/dm³ | | | | | |

TABLE 9
Results of efficiency measurement of liquid complex fertilizer

| | | | | | Percent increase in |
|---|---|---|---|---|---|
| | | | | LCF + | available phosphorus |
| | | LCF + | | polymaleic | concentration when |
| | | polyamino | | acid + polyamino | using a mixture of |
| | | polyether | | polyether | inhibitors relative |
| | | methylene | LCF + | methylene | to addition of |
| | LCF | phosphonic | polymaleic | phosphonic acid | fertilizer without |
| | additive | acid | acid | (composition 2) | inhibitors |
| Concentration | 13.8 | 67.1 | 36.5 | 91.4 | 662.31 |
| of available | | | | | |
| phosphate ions | | | | | |
| in aqueous soil | | | | | |
| extract, mg/dm³ | | | | | |

TABLE 10
Results of efficiency measurement of liquid complex fertilizer

| | | | | | Percent increase in |
|---|---|---|---|---|---|
| | | | | LCF + | available phosphorus |
| | | LCF + | | polymaleic | concentration when |
| | | polyamino | | acid + polyamino | using a mixture of |
| | | polyether | | polyether | inhibitors relative |
| | | methylene | LCF + | methylene | to addition of |
| | LCF | phosphonic | polymaleic | phosphonic acid | fertilizer without |
| | additive | acid | acid | (composition 3) | inhibitors |
| Concentration | 13.8 | 38.5 | 29.6 | 57.6 | 417.39 |
| of available | | | | | |
| phosphate ions | | | | | |
| in aqueous soil | | | | | |
| extract, mg/dm³ | | | | | |

TABLE 11
Results of efficiency measurement of inhibitors in
soil without application of phosphate fertilizers

| | | | | Soil + polymaleic | |
|---|---|---|---|---|---|
| | | | | acid + polyamino | Percent increase in |
| | | Soil + polyamino | | polyether | available phosphorus |
| | | polyether | Soil + | methylene | concentration when |
| | | methylene | polymaleic | phosphonic acid | using a mixture of |
| | Soil | phosphonic acid | acid | (composition 1) | inhibitors |
| Concentration | 3.6 | 15.4 | 8.3 | 27.1 | 752.77 |
| of available | | | | | |
| phosphate ions | | | | | |
| in aqueous soil | | | | | |
| extract, mg/dm³ | | | | | |

TABLE 12
Results of efficiency measurement of inhibitors in
soil without application of phosphate fertilizers

| | | | | Soil + | |
|---|---|---|---|---|---|
| | | | | polymaleic | |
| | | | | acid + polyamino | Percent increase in |
| | | Soil + polyamino | | polyether | available phosphorus |
| | | polyether | Soil + | methylene | concentration when |
| | | methylene | polymaleic | phosphonic acid | using a mixture of |
| | Soil | phosphonic acid | acid | (composition 2) | inhibitors |
| Concentration | 3.6 | 9.9 | 7.3 | 15.7 | 438.11 |
| of available | | | | | |
| phosphate ions | | | | | |
| in aqueous soil | | | | | |
| extract, mg/dm³ | | | | | |

TABLE 13
Results of efficiency measurement of inhibitors in soil
without the application of phosphate fertilizers

| | | | | Soil + | |
|---|---|---|---|---|---|
| | | | | polymaleic | |
| | | | | acid + polyamino | Percent increase in |
| | | Soil + polyamino | | polyether | available phosphorus |
| | | polyether | Soil + | methylene | concentration when |
| | | methylene | polymaleic | phosphonic acid | using a mixture of |
| | Soil | phosphonic acid | acid | (composition 3) | inhibitors |
| Concentration | 3.6 | 7.8 | 6.4 | 13.1 | 363.88 |
| of available | | | | | |
| phosphate ions | | | | | |
| in aqueous soil | | | | | |
| extract, mg/dm³ | | | | | |

1. A composition for phosphorus fertilizers in the form of granules comprising a phosphorus fertilizer and functional additives, which comprise (wt. %):

| | |
|---|---|
| Granular phosphorus fertilizer | 50.0-99.9% |
| Polymaleic acid | 0.05-25.0% |
| Polyamino polyether methylene phosphonic acid | 0.05-25.0% |

2. The composition according to claim 1, characterized in that the phosphorus granular fertilizer is ammophos or diammophos.

3. A composition for phosphorus fertilizers in the form of homogeneous mixture comprising a liquid phosphorus fertilizer and functional additives, which comprise (wt. %):

| | |
|---|---|
| Liquid phosphorus fertilizer | 50.0-99.9% |
| Polymaleic acid | 0.05-25.0% |
| Polyamino polyether methylene | 0.05-25.0% |
| phosphonic acid | |

4. The composition according to claim 3, characterized in that the liquid phosphorus fertilizer is a liquid complex fertilizer.
